(19) United States
(12) Patent Application Publication
(10) Pub. No.: US 2011/0209825 A1
(43) Pub. Date: Sep. 1, 2011

(54) Method for Protecting Optical Devices During Manufacture

(75) Inventors: Randall E. Johnson, Austin, TX (US); Hyunchul Ko, Austin, TX (US); Dung T. Duong, Cedar Park, TX (US); Paul N. Winberg, Rollingwood, TX (US)

(73) Assignee: Illumitex, Inc., Austin, TX (US)

(21) Appl. No.: 13/013,109

(22) Filed: Jan. 25, 2011

Related U.S. Application Data
(60) Provisional application No. 61/298,053, filed on Jan. 25, 2010.

(51) Int. Cl. B32B 37/12

(52) U.S. Cl. 156/308.4

(57) ABSTRACT

This disclosure regards methods for protecting a die during shaping and polishing of optical devices. According to various embodiments, layers can be added and removed from a wafer to protect both sides of the wafer during various steps of a manufacturing process.

### RELATED APPLICATIONS

This application claims the benefit of priority under 35 USC §120 to U.S. Provisional Patent Application No. 61/298,053, entitled “System and Method for Protecting Optical Devices During Manufacture,” by Johnson et. al., filed Jan. 25, 2010, which is hereby fully incorporated by reference herein.

### TECHNICAL FIELD OF THE INVENTION

This disclosure regards optical devices and in particular light emitting diodes (“LEDs”). More particularly, this disclosure relates to protecting a die during shaping and/or polishing of an optical device.

### BACKGROUND OF THE INVENTION

Light emitting diodes (“LEDs”) are ubiquitous in electronics. They are used in digital displays, lighting systems, computers and televisions, cellular telephones and a variety of other devices. Developments in LED technology have led to methods and systems for the generation of white light using one or more LEDs. Developments in LED technology have led to LEDs that generate more photons and thus more light than previously. The culmination of these two technological developments is that LEDs are being used to supplement or replace many conventional lighting sources, e.g. incandescent, fluorescent or halogen bulbs, much as the transistor replaced the vacuum tube in computers.

LEDs are produced in a number of colors including red, green and blue. One method of generating white light involves the use of red, green and blue LEDs in combination with one another. A lighting source that is made of combinations of red, green and blue (RGB) LEDs will produce what is perceived as white light by the human eye. This occurs because the human eye has three types of color receptors, with each type sensitive to either blue, green or red colors.

A second method of producing white light from LED sources is to create light from a single-color (e.g. blue), short wavelength LED, and impinge a portion of that light onto phosphor or similar photon conversion material. The phosphor absorbs the higher energy, short wavelength light waves, and re-emits lower energy, longer wavelength light. If a phosphor is chosen that emits light in the yellow region (between green and red), for example, the human eye perceives such light as white light. This occurs because the yellow light stimulates both the red and green receptors in the eye. Other materials, such as nano-particles or other similar photo-luminescent materials, may be used to generate white light in much the same way.

White light may also be generated utilizing an ultraviolet (UV) LED and three separate RGB phosphors. White light may also be generated from a blue LED and a yellow LED and may also be generated utilizing blue, green, yellow and red LEDs in combination.

Current industry practice for construction of LEDs is to use a substrate (typically either single-crystal Sapphire or Silicon Carbide), onto which is deposited layers of materials such as GaN or InGaN. One or more layers (e.g. GaN or InGaN) may allow photon generation and current conduction. Typically, a first layer of Gallium Nitride (GaN) is applied to the surface of the substrate to form a transition region from the crystal structure of the substrate to the crystal structure of doped layers allowing for photon generation or current conduction. This is typically followed by an N-doped layer of GaN. The next layer can be an InGaN, AlGaN, AlInGaN or other compound semiconductor material layer that generates photons and that is doped with the needed materials to produce the desired wavelength of light. The next layer is typically a P doped layer of GaN. This structure is further modified by etching and deposition to create metallic sites for electrical connections to the device.

### SUMMARY

This disclosure regards methods for protecting a die during shaping and polishing of optical devices. According to various embodiments, layers can be added and removed from a wafer to protect both sides of the wafer during various steps of a manufacturing process.

One embodiment can include a method of protecting optical devices that includes applying an exit face protecting layer on a first side of a wafer to protect a substrate material and applying a protective material on a second side of the wafer obverse from the first side to protect the wafer during shaping of one or more optical devices. The protective material can be selected to allow shaping of the wafer into the one or more optical devices through the protective material. After shaping the wafer into one or more optical devices (each optical device having an exit face on the first side and an end on the second side), an embodiment of the method can include removing the protective material from the second side and applying an end cover material on the second side. The end cover material can be selected to protect non-substrate layers of the wafer during removal of the exit face protecting layer. The method can further include removing the exit face protecting layer. Additionally, the method can further include adhering a layer of material to the exit faces of the one or more optical devices after removing the exit face protecting layer and removing the end cover material.

According to one embodiment, the exit face protecting layer can be adhered on the first side of the wafer using an adhesive. To promote adhesion, one embodiment of the method can include applying an adhesion promoting material to the adhesive or the second side of the wafer prior to applying the exit face protecting layer, the adhesion promoting material selected to promote adhesion between the adhesive and the wafer. In one embodiment, the exit face protecting layer can be removed by chemically removing the exit face protecting layer, adhesion promoting layer and adhesive. In another embodiment, the exit face protecting layer can be removed by heating the exit face protecting layer and adhesive to cause the adhesive to soften. The exit face protecting layer can then be removed mechanically. By way of example, the exit face protecting layer and adhesive can be heated by submerging the wafer in hot water.

Various layers can be applied in multiple steps. For example, applying the cover material can include applying a first end cover material on an end of each of the one or more optical devices and applying a second end cover material to the second side using the first end cover material to adhere the second end cover material on the second side.

Those of ordinary skill in the art would understand that the various steps described above can be performed in a variety of orders. For example, the exit face protecting layer and the protective material can be applied in any order. Additionally, it should be understood that the various layers can be coupled to the wafer directly or through intermediate layers.

Embodiments described herein can provide support for an array of optical devices as the optical devices are shaped. The exit face protecting material can be selected to protect the substrate material and provide a support for the array of optical devices in subsequent manufacturing steps and the adhesive used to adhere the exit face protecting material to the wafer can be selected to maintain the optical devices in the array during a shaping process. Additionally, the end cover material can maintain the optical devices in the array when the exit face protecting material is removed.

### BRIEF DESCRIPTION OF THE FIGURES

A more complete understanding of the embodiments and the advantages thereof may be acquired by referring to the following description, taken in conjunction with the accompanying drawings in which like reference numbers indicate like features and wherein:

FIG. 1 is a diagrammatic representation of one embodiment of a stack of layers;

FIG. 2 is a diagrammatic representation of one embodiment of wafer after shaping portions of the substrate;

FIGS. 3A-3E are diagrammatic representations of embodiments of a method for removing layers;

FIG. 4 is a diagrammatic representation of adhering a material to the exit faces of optical devices; and

FIG. 5 is a diagrammatic representation of embodiments of optical devices adhered to a material.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known starting materials and processes may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Furthermore, while embodiments are described herein primarily with respect to protecting optical devices as the optical devices are shaped to have curved sidewalls, embodiments described herein may be used in the manufacture of optical devices with straight or otherwise shaped sidewalls.

Reference is now made in detail to the exemplary embodiments of the disclosure, examples of which are illustrated in the accompanying drawings. Wherever possible, like numerals will be used throughout the drawings to refer to like and corresponding parts (elements) of the various drawings.

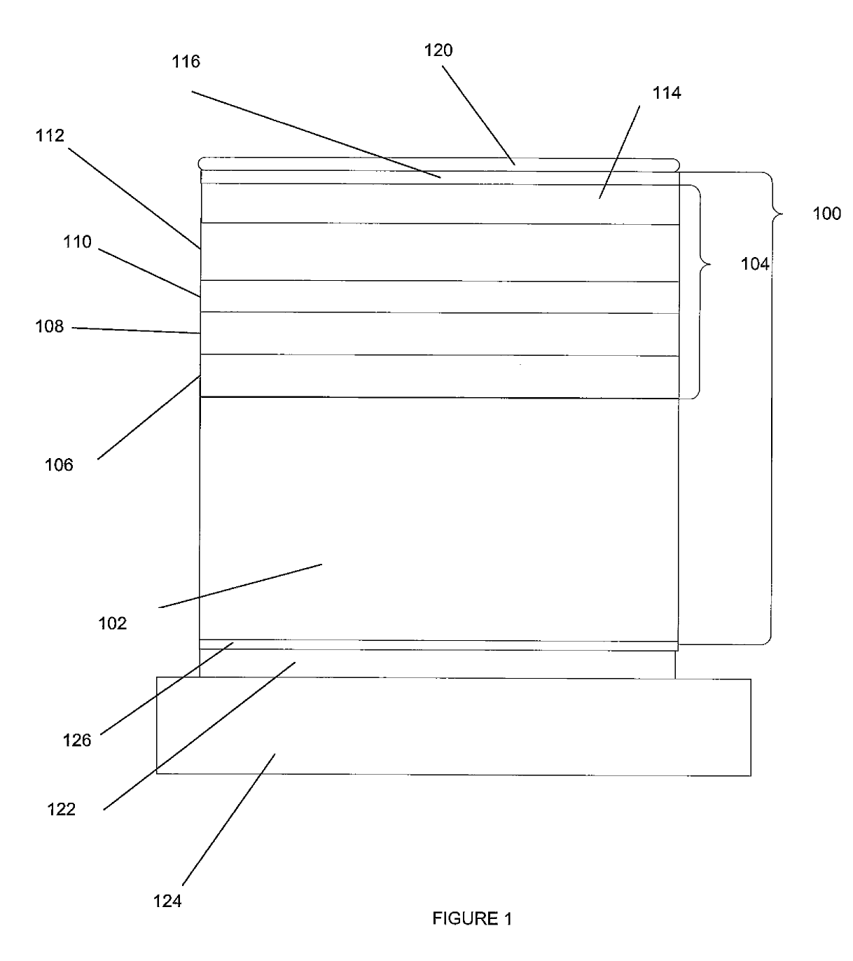

FIG. 1 is a diagrammatic representation of one embodiment of a stack of layers of an LED wafer 100 prepared for manufacturing. In the embodiment of FIG. 1, the wafer can comprise a substrate 102 and a quantum well region 104. Substrate 102 can be formed of any suitable substrate material including, but not limited to, sapphire, silicon carbide, glass or diamond. Quantum well region 104 can be formed using suitable photon generating layers. In many optical device applications, quantum well region 104 is formed from multiple layers of GaN based materials and can, therefore be referred to as the GaN layers. For example, layer 106 can be an n-type GaN buffer layer, layer 108 can be in n-type AlGaN layer, layer 110 can be a photon generating layer, such as InGaN, layer 112 can be a p-type layer, such as p-type Al—GaN layer and layer 114 can be a contact layer, such as GaN layer. It should be noted that the layers described are provided by way of example and any suitable layers can make up the quantum well region of the wafer. In addition to substrate 102 and quantum well region 104, may include a metallization layer 116 and other layers.

During manufacture, wafer 100 may be shaped into multiple optical devices. The number and size of the optical devices can be chosen as needed or desired. In one embodiment, for example, over 1500 optical devices can be formed from a wafer having a two inch diameter. U.S. Provisional Patent Application No. 61/075,972, U.S. patent application Ser. No. 11/906,194, U.S. patent application Ser. No. 11/906,219, U.S. Provisional Patent Application No. 60/881,785, U.S. patent application Ser. No. 12/492,599, and U.S. patent application Ser. No. 12/492,472, each of which is hereby fully incorporated by reference herein, describe various methods for shaping and polishing a wafer to produce optical devices. Embodiments described herein can be used in conjunction with the shaping and polishing methods described in the above-referenced applications or with other shaping and polishing methods.

The shaping and polishing methods applied may utilize abrasive particles that can damage the layers of the wafer 100 or may require the application of force to the optical devices being manufactured. For example, abrasive particles can damage metallization layer 116 and the pressure applied during polishing can cause the optical devices formed from wafer 100 to separate, making it difficult to polish a large number of optical devices quickly. Embodiments described herein provide a system and method to support and protect the wafer during shaping and/or polishing. In addition, embodiments described herein can provide a convenient structure that allows the wafer to be easily passed between the various manufacturing stages.

Because various manufacturing methods can include the use of abrasive particles or other components that may damage the metallization layer 116 or quantum well region 104, a protective material can be applied to the side of wafer 100 proximate to these layers. The protective material can be chosen to withstand abrasive interaction with particles or other potentially damaging actions. For example, protective layer 120 can be chosen to protect wafer 100 from slurries of deionized water/glycol with diamond particles having sizes of less than one micron to 60 microns for a selected period of time (e.g., one hour, two hours, 24 hours or other selected time period). Furthermore, protective layer 120 can be selected so that the shaping process can shape the substrate material through protective layer 120.

According to one embodiment protective layer 120 is a resilient thermoplastic that will adhere to the outermost layer of wafer 100 and can have a cure durometer of a desired range. The material of protective layer 120 can be chosen based on the manufacturing methods to be employed, time constraints, and other factors. For example, a relatively tacky protective layer 120 may be suitable for a wire saw shaping method, but may gum up an ultrasonic shaping tool. Examples of materials that can be used as protective layer 120 include Cookson Staystik 393 or other suitable adhesives. The thickness of protective layer 120 can depend on material used in protective layer 120 and manufacturing process parameters.

On the other side of wafer 100, layer 124 can protect the surface of substrate 102 to act as an exit face protecting layer 124. Layer 124 can be formed of various materials including, but not limited to, glass, wax, epoxy, sapphire, silicone or other suitable materials. The material selected can depend on the shaping or polishing methods used. According to one embodiment, layer 124 can be selected to support wafer 100 and, in some cases, act as a sacrificial layer during the optical device manufacturing process.

Layer 124 can be coupled to wafer 100 using an adhesive 122 selected to be strong enough to hold layer 124 and substrate 102 together during the manufacturing processes. In particular, adhesive 122 can be selected based on the maximum lateral forces applied to optical devices during shaping or polishing to hold the optical devices to layer 124. In addition, embodiments of adhesive 122 can be selected to have resistance to long exposure to deionized water, glycol and abrasives materials for processes that utilize abrasive slurries in shaping or polishing. Examples of adhesives include, but are not limited to, Valtron AD4010-A/AD4015-B Heat Release Epoxy System (MP4010A/1015B-50) by Valtech Corporation of Saratoga, Pa., Liofol UR 9640 epoxy by Henkel Corporation of Rocky Hill, Conn., Cookson Staystik 393 or other adhesive. The adhesive can be applied through any suitable method including, for example, by spin coating the adhesive on layer 124 or substrate 102.

An adhesion promoting layer 126 can be added to promote adhesion between adhesive 122 and substrate 102 or layer 124. According to one embodiment, adhesion promoting layer can be formed of a metal, such as Ti, Titanium-Tungsten alloy, SiO₂ or other material. As an example, an approximately 1 micron thick layer of Ti can powder coat substrate 102. Adhesion promoting layer 126, in other embodiments, can be applied to layer 124.

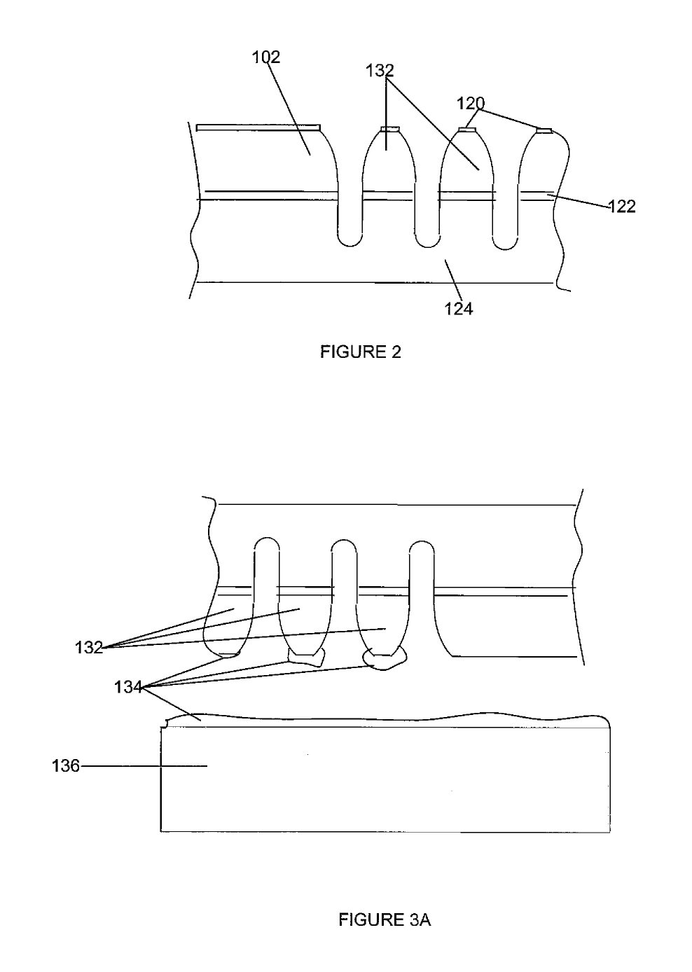

FIG. 2 is a diagrammatic representation of one embodiment of wafer 100 after shaping portions of the substrate 102. FIG. 2 illustrates substrate material 102 in which the substrate portions 132 of the optical devices have been formed. As illustrated in FIG. 2, protective layer 124 has been partially removed during the shaping process. When wafer 100 has been shaped to desired specifications, the various protective layers can be removed using any suitable method. For example, a thermoplastic protective layer may be removed using chemicals such as acetone. The method applied to remove protective layer 120 can be chosen to prevent or minimize damage to the quantum well region 104 and any metallization or other layers of wafer 100. While in this example the protective layer 120 is removed first, in other embodiments layer 124 may be removed first.

To remove layer 124, wafer 100 can be exposed to acid or other agent sufficient to remove adhesion promoting layer 126, adhesive 122 or layer 124. For example, wafer 100 can be exposed to hydrofluoric acid, which is highly reactive to glass and can dissolve metals. Consequently, hydrofluoric acid can eat through adhesion promoting layer 126 and protective layer 124. In another embodiment, wafer 100 can be heated to cause adhesive 122 to loosen. For example, wafer 100 can be submerged in boiling water or otherwise heated for a sufficient period of time to allow adhesive 122 to loosen and layer 124 to be easily removed. Removal of layer 124 prior to exposing the wafer 100 to acid can reduce the time wafer 100 is in the acid, thereby reducing the chance for damage.

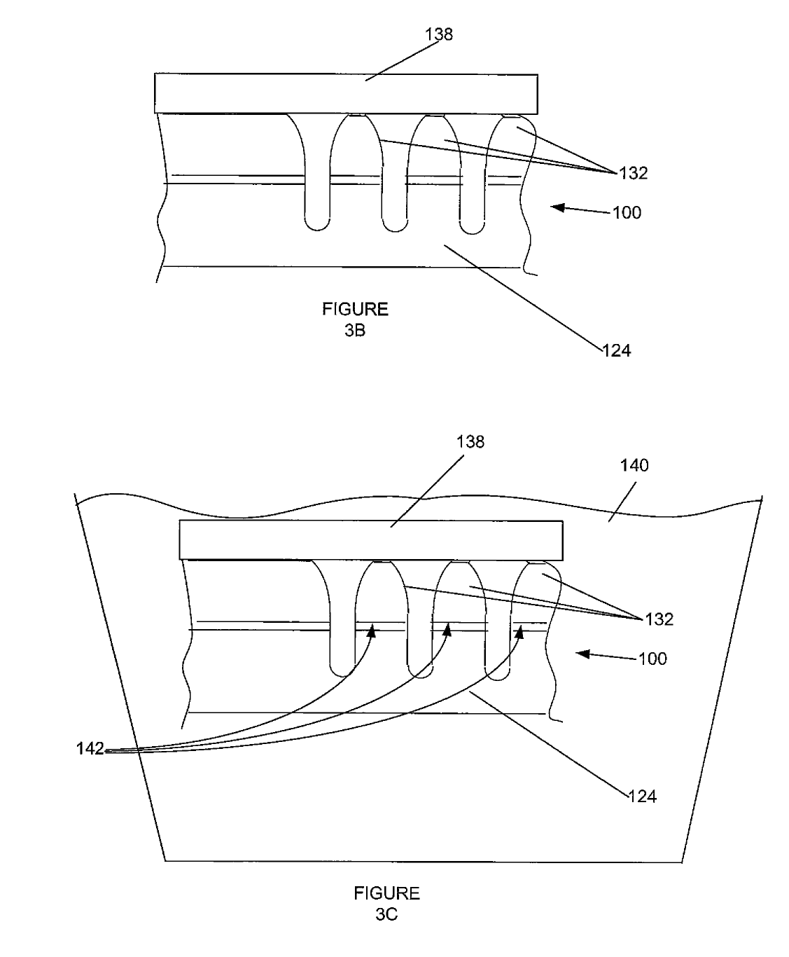

FIGS. 3A-3E are diagrammatic representations of one embodiment of a method for removing layer 124 and adhesion promoting layer 126. Protective layer 120 may be insufficient to protect the metallization layers during removal of layer 124 or adhesion promoting layer 126 due to the corrosiveness of the acid used. Accordingly, protective layer 120 can be removed and a new cover added. In one embodiment, a second cover material can be added that is selected to protect the ends of optical devices 132 during subsequent steps. By way of example, but not limitation a thermoplastic layer, glass, sapphire or other material can be used to cover the ends of the optical devices 132. The material selected can depend on the other steps of the manufacturing process.

According to one embodiment, a first cover layer material 134 can be spin coated on a material 136 and, as shown in FIG. 3A, and the ends of the optical devices can be dipped in material 134. The cover layer material 134 can be allowed to partially or fully cure. This process can be repeated any number of times to build up a layer of material 134. In some cases, material 134 may be sufficient to act as the cover layer. In other cases, an additional cover material can be added. For example, before the last coat of first cover material 134 cures, an additional cover material 138 (shown in FIG. 3B) can be adhered (or otherwise coupled) to wafer 100 using material 134. Cover material 138 may or may not be the same as material 136. Cover material 138 can protect the ends of optical devices 132 in subsequent steps and allow wafer 100 to be manipulated after layer 124 is removed. The material(s) used to cover the ends of the optical devices can depend on the remaining steps of manufacture, whether the wafer must be handled by the cover or other factors. According to an embodiments in which material 134 acts as an adhesive for material 138, material 134 can be any suitable adhesive such as, but not limited to, Valtron AD4010-A/AD4015-B Heat Release Epoxy System (MP4010A/1015B-50) by Valtech Corporation of Saratoga, Pa., Liofol UR 9640 epoxy by Henkel Corporation of Rocky Hill, Conn., Cookson Staystik 393, Cookson Staystik 383 or other adhesive. Material 138 can be a material that preferably allows handling and protects the ends of the optical devices during subsequent steps. Material can 138 can be, for example, sapphire, silicon carbide, glass or other material such that material 138 acts as a protective plate. By way of example, a layer of sapphire 138 can be adhered to wafer 100 using Cookson Staystik 393 to protect the optical devices from hydrofluoric acid used in embodiments of subsequent steps.

In the embodiment of FIG. 3C, all or the entire structure can be placed in an acid 140 that can eat away any adhesion promoting layer 126, adhesive 122 and layer 124 to cause the exit faces 142 of optical devices 132 to become exposed. For example, if adhesion promoting layer 126 is a layer of Ti, adhesive layer 122 is Liofol UR 9640 epoxy and layer 124 is glass, the structure can be placed in hydrofluoric acid which can eat away Ti layer 126 to cause adhesive 122 to fall off. The hydrofluoric acid, in this case, can also dissolve glass 124. Other acids that can dissolve adhesion promoting layer 126 can be used, such as nitric acid, hydrogen peroxide, and other acids or chemicals.

In another embodiment, shown in FIGS. 3D-E, the structure can be heated to cause adhesive 122 to soften. According to one embodiment, wafer 100 can be placed in boiling water 144 or otherwise exposed to heat for a sufficient period of time to loosen the adhesive 122. In the case of Liofol UR 9640 epoxy, for example, the structure can be placed in boiling water for an hour or longer causing adhesive 122 to release. Layer 124 and all or a portion of adhesive 122 can then be pulled off easily. The remaining structure can be placed in acid 140 as shown in FIG. 3E to remove adhesion promoting layer 126 and remaining adhesive 122. By removing layer 124 and potentially some of adhesive 122 prior to applying acid 140, acid 140 can remove adhesion promoting layer 126 more quickly.

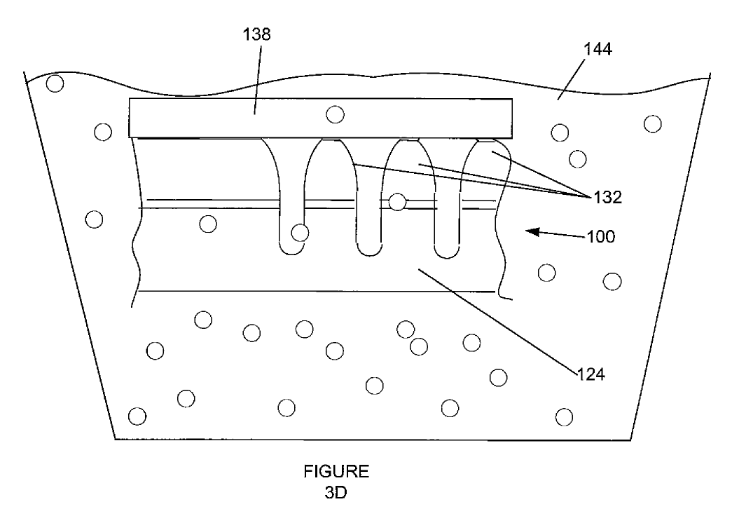

At this point, the exit faces 142 of the optical devices are exposed, as shown in FIG. 4, and material 134 and material 138 can be removed. However, it may be desirable to keep optical devices 132 in an array during subsequent processing. According to one embodiment, exit faces 142 can be adhered (or otherwise coupled) to a material that is relatively easy to remove. FIG. 4, for example, is a diagrammatic representation of adhering exit faces 142 to tape 148, such as optical UV tape or other tape.

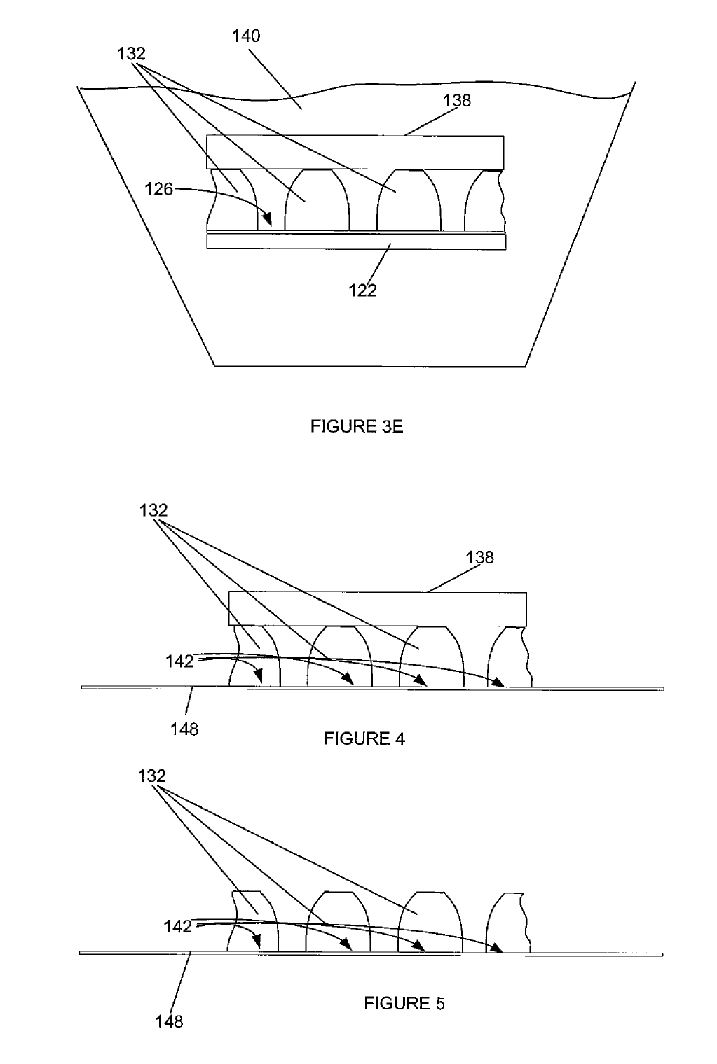

The cover material can be removed in any suitable manner. In one embodiment, for example, material 134 can be exposed to steam to cause material 134 to soften. Material 138 can then be easily removed. If remaining material 134 is an adhesive as described above, it can be mechanically or chemically removed or otherwise removed. For example, many epoxies can be removed using acetone or other solvent that will not damage or do minimal damage to the optical device. As shown in the embodiment of FIG. 5, the optical devices can remain adhered (or otherwise coupled) to tape 148 after removal of the cover layer. Thus, the optical devices can be maintained in an array throughout the manufacturing process by various layers in the set of layers applied.

While this disclosure describes particular embodiments, it should be understood that the embodiments are illustrative and that the scope of the invention is not limited to these embodiments. Many variations, modifications, additions and improvements to the embodiments described above are possible. For example, the various materials, ranges and dimensions provided are provided by way of example. Moreover, while the substrates have been described in regard to sapphire and silicon carbide, other substrates may be used. For example, substrates may be made of glass or diamond. In one embodiment, substrates may be molded from moldable glass, providing a cost effective and easily shaped substrate. It is contemplated that these variations, modifications, additions and improvements fall within the scope of the claims.

What is claimed is:

1. A method of protecting optical devices during manufacture, comprising:
applying an exit face protecting layer on a first side of a wafer to protect a substrate material;
applying a protective material on a second side of the wafer obverse from the first side to protect the wafer during shaping of one or more optical devices, wherein the protective material is selected to allow shaping of the wafer into the one or more optical devices through the protective material;
after shaping the wafer into one or more optical devices, each optical device having an exit face on the first side and an end on the second side:
removing the protective material from the second side of the wafer;
applying an end cover material on the second side after removing the protective material, the end cover material selected to protect non-substrate layers of the wafer during removal of the exit face protecting layer; and
removing the exit face protecting layer.

2. The method of claim 1, wherein applying the exit face protecting layer comprises adhering the exit face protecting layer to the first side of the wafer using an adhesive.

3. The method of claim 2, further comprising applying an adhesion promoting material to the adhesive or the second side of the wafer prior to applying the exit face protecting layer, the adhesion promoting material selected to promote adhesion between the adhesive and the wafer.

4. The method of claim 3, wherein applying the end cover material further comprises:
applying a first end cover material on an end of each of the one or more optical devices;
applying a second end cover material to the second side using the first end cover material to adhere the second end cover material on the second side.

5. The method of claim 3, wherein removing the exit face protecting layer comprises chemically removing the exit face protecting layer, adhesion promoting layer and adhesive.

6. The method of claim 3, wherein removing the exit face protecting layer further comprises:
heating the exit face protecting layer and adhesive to cause the adhesive to soften;
mechanically removing the exit face protecting layer;
chemically removing the adhesion promoting layer.

7. The method of claim 6, further comprising submerging the wafer in boiling water to heat the exit face protecting layer and adhesive.

8. The method of claim 3, wherein removing the exit face protecting layer further comprises chemically removing at least one of the exit face protecting layer, adhesive or adhesion promoting layer using hydrofluoric acid and wherein the end cover material is selected to protect the second side from hydrofluoric acid.

9. The method of claim 1, further comprising
adhering a layer of material to the exit faces of the one or more optical devices after removing the exit face protecting layer; and
removing the end cover material.

10. A method of protecting optical devices using a set of layers during manufacture, comprising:
providing a wafer having a first side and a second side;
adhering an exit face protecting layer on a first side of a wafer using an adhesive, the exit face protecting layer selected to protect a substrate material and provide a support for an array of optical devices in subsequent manufacturing steps and the adhesive selected to maintain the optical devices in the array during a shaping process;
applying a protective material on a second side of the wafer obverse from the first side to protect the wafer during shaping of one or more optical devices, wherein the protective material comprises a thermoplastic selected to allow shaping of the wafer into the one or more optical devices through the protective material;
after shaping the wafer into the array of one or more optical devices, each optical device having an exit face on the first side and an end on the second side:
removing the protective material from the second side of the wafer;
applying an end cover material on the second side after removing the protective material, the end cover material selected to protect non-substrate layers of the wafer during removal of the exit face protecting layer; and
removing the exit face protecting layer;
adhering a layer of optical tape to the exit faces of the one or more optical devices after removing the exit face protecting layer; and
removing the end cover material,
wherein the optical devices are maintained in the array until the layer of optical tape is applied by one or more layers in the set of layers.

11. The method of claim 10, wherein the exit face protecting layer comprises a layer selected from one of glass, wax, epoxy, sapphire or silicone.

12. The method of claim 10, further comprising applying an adhesion promoting layer to promote adhesion between the wafer and the adhesive.

13. The method of claim 11, wherein the adhesion promoting layer comprises a layer of Ti.

14. The method of claim 13, wherein applying the end cover material further comprises:
applying a first end cover material on an end of each of the one or more optical devices;
applying a second end cover material to the second side using the first end cover material to adhere the second end cover material on the second side.

15. The method of claim 13, wherein removing the exit face protecting layer comprises chemically removing the exit face protecting layer, adhesion promoting layer and adhesive.

16. The method of claim 13, wherein removing the exit face protecting layer further comprises:
heating the exit face protecting layer and adhesive to cause the adhesive to soften;
mechanically removing the exit face protecting layer;
chemically removing the adhesion promoting layer.

17. The method of claim 16, further comprising submerging the wafer in boiling water to heat the exit face protecting layer and adhesive.

18. The method of claim 13, wherein removing the exit face protecting layer further comprises chemically removing at least one of the exit face protecting layer, adhesive or adhesion promoting layer using hydrofluoric acid and wherein the end cover material is selected to protect the second side from hydrofluoric acid.
